(19) United States
(12) Patent Application Publication
(10) Pub. No.: US 2024/0402412 A1
(43) Pub. Date: Dec. 5, 2024

(54) BACKLIGHT MODULE AND DISPLAY DEVICE

(71) Applicant: Coretronic Corporation, Hsin-Chu (TW)

(72) Inventors: Kuan-Wen Liu, Hsin-Chu (TW); Chao-Hung Weng, Hsin-Chu (TW); Hao-Jan Kuo, Hsin-Chu (TW); Ming-Dah Liu, Hsin-Chu (TW)

(73) Assignee: Coretronic Corporation, Hsin-Chu (TW)

(21) Appl. No.: 18/674,912

(22) Filed: May 26, 2024

(30) Foreign Application Priority Data
Jun. 2, 2023 (CN) 202321385048.X

(51) Int. Cl. F21V 8/00; G02F 1/13357

(52) U.S. Cl. CPC G02B 6/0051; G02B 6/0053; G02F 1/133615

(57) ABSTRACT

A backlight module includes a light guide plate, a light source, an optical film, and first and second prism sheets. The light source and the optical film are respectively located on a light incident surface and a light exit surface of the light guide plate. The optical film includes a substrate and optical microstructures including first and second inclined surfaces and having an extending direction parallel to the light incident surface. There are respectively first and second base angles between the first and second inclined surfaces and a surface of the substrate. An angle range of the first and second base angles is 50 to 70 degrees. The first and second prism sheets t each have prism structures. An angle range of an included angle between extending directions of the optical microstructures and the prism structures is 85 to 95 degrees. A display device having the backlight module is proposed.

### CROSS-REFERENCE TO RELATED APPLICATION

This application claims the priority benefit of China application serial no. 202321385048.X filed on Jun. 2, 2023. The entirety of the above-mentioned patent application is hereby incorporated by reference herein and made a part of this specification.

### BACKGROUND OF THE INVENTION

### Field of the Invention

The invention relates to a backlight module and a display device.

### Description of Related Art

As a light source for a non-self-luminous display (such as a liquid-crystal display), the performance of the backlight module determines the competitiveness of a non-self-luminous display product. For example, when the display has the same luminance, if the backlight module has low power consumption, not only may energy be saved to prolong battery life, but also heat generation may be reduced. Reducing the thickness and the weight of the backlight module may also make the display better meet the needs of users. Therefore, improving the luminance of the backlight module while reducing the power consumption and the thickness of the backlight module has always been a subject of concern for relevant manufacturers, but the performance of the backlight module still needs to be improved.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a backlight module having advantages such as small thickness, high assembly yield, good light collection performance, and high luminance gain.

The invention provides a display device having the advantages of low thickness, low power consumption, high display brightness, and good yield.

Other objects and advantages of the invention may be further understood from the technical features disclosed in the invention.

An embodiment of the invention provides a backlight module including a light guide plate, a light source, an optical film, a first prism sheet, and a second prism sheet. The light guide plate has a light incident surface and a light exit surface connected to each other. The light source is disposed at a side of the light incident surface of the light guide plate, and the optical film is overlapped with the light exit surface of the light guide plate. The optical film includes a substrate and a plurality of optical microstructures. The substrate has a surface, and the plurality of optical microstructures are disposed on the surface of the substrate. An extending direction of the plurality of optical microstructures is substantially parallel to the light incident surface. Any one of the plurality of optical microstructures includes a first inclined surface and a second inclined surface, there is a first base angle between the first inclined surface and the surface, and there is a second base angle between the second inclined surface and the surface of the substrate, wherein the first base angle and the second base angle are between 50 degrees and 70 degrees. The first prism sheet and the second prism sheet are superimposed at the optical film and each has a plurality of prism structures. The plurality of prism structures of the first prism sheet have a first extending direction, and the plurality of prism structures of the second prism sheet have a second extending direction. An angle range of an included angle between the extending direction of the plurality of optical microstructures and the first extending direction is 85 degrees to 95 degrees. An angle range of an included angle between the extending direction of the plurality of optical microstructures and the second extending direction is 85 degrees to 95 degrees.

An embodiment of the invention provides a display device, including the backlight module and a display panel. In particular, the display panel is disposed on the backlight module.

Based on the above, the backlight module of the invention may only include one optical film and two prism sheets in an exit light direction of the light exit surface of the light guide plate to further reduce the overall thickness of the backlight module. The manufacturing difficulty and the cost of the backlight module are reduced, and the product yield rate is further increased. Moreover, on the basis of the above architecture, since an angle range of the base angles of the optical microstructures on the optical film is 50 degrees to 70 degrees, the actually measured luminance gain of the backlight module of the invention may reach 182%, thus significantly improving the luminance of the backlight module and improving the brightness and the light extraction efficiency of the display device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display device of the first embodiment of the invention.

FIG. 2A is a side view of a backlight module of the first embodiment of the invention.

FIG. 2B is a top view of a backlight module of the first embodiment of the invention.

FIG. 3 is a side view of a backlight module of the second embodiment of the invention.

FIG. 4 is a side view of a backlight module of the third embodiment of the

invention.

FIG. 5 is a side view of a backlight module of the fourth embodiment of the invention.

FIG. 6 is a side view of a backlight module of the fifth embodiment of the invention.

FIG. 7 is a side view of a backlight module of the sixth embodiment of the invention.

FIG. 8 is a side view of a backlight module of the seventh embodiment of the invention.

FIG. 9 is a side view of a backlight module of the eighth embodiment of the invention.

FIG. 10 is a top view of a backlight module of the ninth embodiment of the invention.

FIG. 11 is a top view of a backlight module of the tenth embodiment of the invention.

FIG. 12 is a schematic diagram of optical backtracking simulating a light guide plate and optical microstructures with different base angles of the invention.

FIG. 13A to FIG. 13C are graphs of the relationship between parameters and luminance gain of simulating optical microstructures of the invention.

FIG. 14A to FIG. 14D are graphs of the relationship between various parameters and luminance gain of simulating optical microstructures of the invention on the basis of fixed second base angle.

FIG. 15A and FIG. 15B are brightness distribution diagrams obtained by actually measuring an example of the backlight module of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

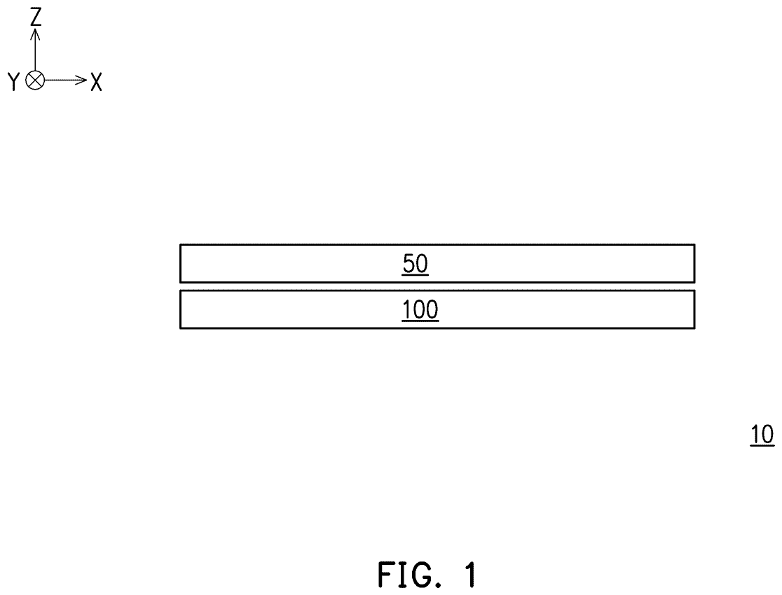

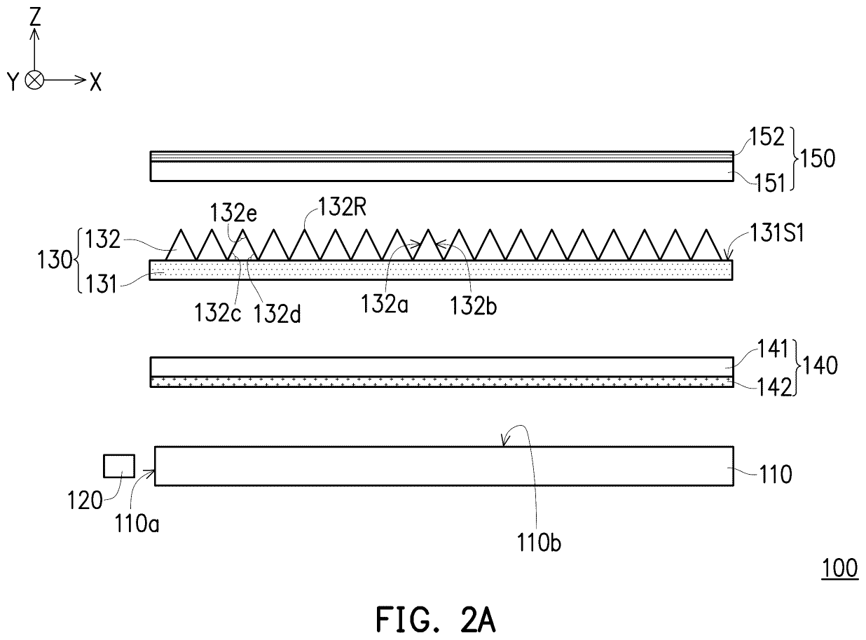

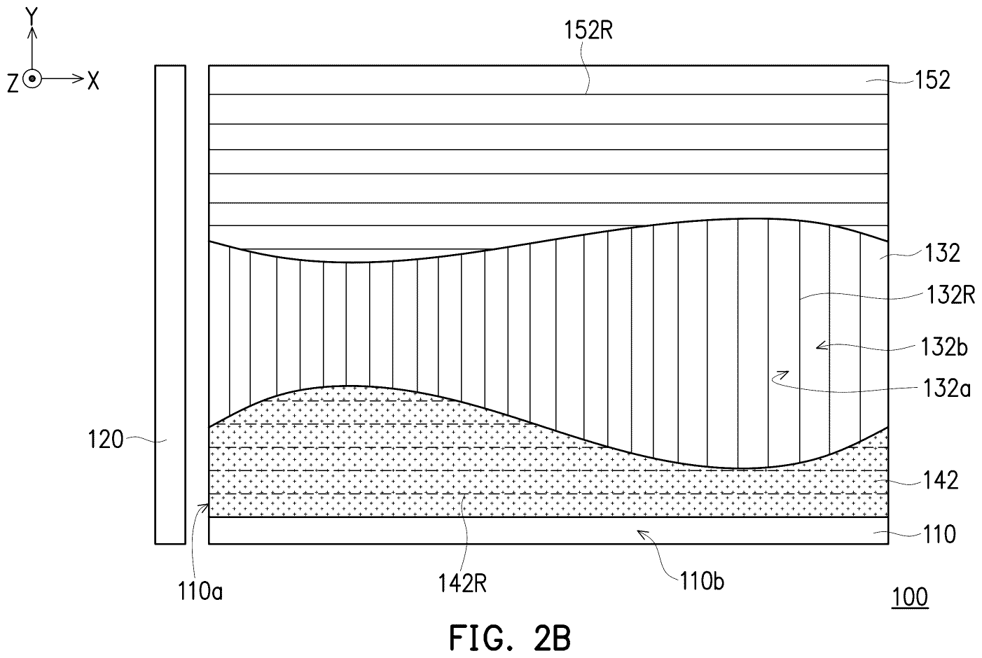

FIG. 1 is a schematic diagram of a display device of the first embodiment of the invention. FIG. 2A is a side view of a backlight module of the first embodiment of the invention. FIG. 2B is a top view of a backlight module of the first embodiment of the invention. In order to facilitate the presentation of the extended relationship of optical microstructures 132, prism structures 142, and prism structures 152, FIG. 2B omits the illustration of a substrate 131, a carrier plate 141, and a carrier plate 151 in FIG. 2A. Please refer to FIG. 1 to FIG. 2A at the same time. A display device 10 includes a display panel 50 and a backlight module 100, and the display panel 50 is disposed on the backlight module 100. In particular, the backlight module 100 includes a light guide plate 110, a light source 120, an optical film 130, a first prism sheet 140, and a second prism sheet 150.

The display panel 50 may be, for example, a non-self-luminous display, including a display medium layer, a pixel circuit layer, pixel electrodes, data lines, scan lines, and corresponding driving circuits (not shown), to drive the display medium layer (such as liquid-crystal layer) corresponding to the pixels on the display panel 50. The backlight module 100 provides light to the display panel 50 to generate a corresponding display image. That is, the display panel 50 of the invention may be a liquid-crystal display, but the invention is not limited thereto.

The light guide plate 110 has a light incident surface 110a and a light exit surface 110b connected to each other. The light source 120 is disposed at a side of the light incident surface 110a of the light guide plate 110, that is, the backlight module of the invention may be an edge-light-type backlight module, but is not limited thereto. In other embodiments, the light source 120 may be disposed to be in direct contact with the light incident surface 110a of the light guide plate 110. In other embodiments, the light incident surface 110a may be concave in the light guide plate 110, and the light source 120 may be disposed in the light incident surface 110a of the light guide plate 110. That is, the light source 120 may be placed in the light guide plate 110, but the invention is not limited thereto. The material of the light guide plate 110 may be, for example, polymethyl methacrylate (PMMA), polystyrene (PS), or polycarbonate (PC), and the light source 120 may adopt a light bar including a light-emitting diode (LED) or a cold cathode tube (CCFL), but the invention is not limited thereto. In order to allow light to exit from the light exit surface 110b of the light guide plate 110, dots or microstructures (not shown) may be disposed at the bottom surface opposite to the light exit surface 110b. When the light emitted by the light source 120 hits the dots at the bottom surface, the light is diffusely reflected at different angles to break the total reflection condition or reflected by the dots to change light path, so that the light may exit from the light exit surface 110b of the light guide plate 110.

Referring to FIG. 2A and FIG. 2B, the optical film 130 is overlapped with the light exit surface 110b of the light guide plate 110. Specifically, the optical film 130 may adjust the light emitted from the light exit surface 110b to increase the luminance of the backlight module 110 at a vertical viewing angle. Furthermore, the optical film 130 further includes a substrate 131 and a plurality of optical microstructures 132, and the plurality of optical microstructures 132 are disposed on a surface 131S1 of the substrate 131 facing away from the light guide plate 110. The extending direction (for example, a direction Y in FIG. 2A and FIG. 2B) of the optical microstructures 132 may be substantially parallel to the light incident surface 110a of the light guide plate 110. For example, the extending direction of a ridge line 132R of the optical microstructures 132 may be substantially parallel to the light incident surface 110a. The material of the optical microstructures 132 may be formed by curing a light-transmitting adhesive, and a range of the refractive index of the light-transmitting adhesive after curing may be 1.56 to 1.59. For example, the optical film 130 of the present embodiment is, for example, a high gain brightness enhancement film (high gain BEF), so the luminance of the backlight module 100 may be increased.

More specifically, any one of the plurality of optical microstructures 132 includes a first inclined surface 132a and a second inclined surface 132b, there is a first base angle 132c between the first inclined surface 132a and the surface 131S1 of the substrate 131, and there is a second base angle 132d between the second inclined surface 132b and the surface 131S1 of the substrate 131. It is worth mentioning that an angle range of the first base angle 132c may be 50 degrees to 70 degrees, and an angle range of the second base angle 132d may also be 50 degrees to 70 degrees. In some embodiments, the first base angle 132c and the second base angle 132d may be substantially equal. Via the above design, the light output from the light guide plate 110 in the direction of the normal viewing angle (such as a direction Z in FIG. 2A and FIG. 2B) may be effectively improved, so that the backlight module 100 has better optical performance. And it may be shown in the relevant simulation and actual measurement that, compared with the traditional backlight module configuration, the brightness gain of the backlight module 100 of the present embodiment may reach 1.82 times (described later).

Moreover, the first prism sheet 140 and the second prism sheet 150 are overlapped with the optical film 130. More specifically, the first prism sheet 140 and the second prism sheet 150 are disposed at a side of the light exit surface 110b of the light guide plate 110. Moreover, the optical film 130 is disposed between the first prism sheet 140 and the second prism sheet 150, and the first prism sheet 140 is located between the optical film 130 and the light guide plate 110. Moreover, the first prism sheet 140 has the carrier plate 141 and the plurality of prism structures 142. The plurality of prism structures 142 are respectively disposed on the carrier plate 141 and disposed facing the light exit surface 110b of the light guide plate 110 (for example, reversed prism sheets). However, the invention is not limited thereto, and in other embodiments, the plurality of prism structures 142 may also be disposed away from the light exit surface 110b of the light guide plate 110 (for example, front prism sheets). Moreover, the second prism sheet 150 also has the carrier plate 151 and the plurality of prism structures 152, and the plurality of prism structures 152 are respectively disposed on the carrier plate 151, and are disposed facing away from the light exit surface 110b of the light guide plate 110 (for example, front prism sheets). The material of the carrier plate 141 and the carrier plate 151 is, for example, polymethyl methacrylate (PMMA), polystyrene (PS), or polycarbonate (PC), and the material of the plurality of prism structures 142 and the plurality of prism structures 152 may include UV glue or other suitable polymers. In some other embodiments, a range of the refractive index of the plurality of prism structures 142 and the plurality of prism structures 152 may be 1.46 to 1.7. In the present embodiment, the first prism sheet 140 and the second prism sheet 150 are, for example, high gain brightness enhancement films (high gain BEFs), so the luminance of the backlight module 100 may be increased. However, the invention is not limited thereto.

Moreover, the plurality of prism structures 142 of the first prism sheet 140 may have a first extending direction, and the first extending direction may be substantially perpendicular to the light incident surface 110a of the light guide plate 110. More specifically, the extending direction of ridge lines 142R of the plurality of prism structures 142 is, for example, substantially parallel to a direction X in FIG. 2B. From another perspective, since the extending direction of the optical microstructures 132 may be substantially parallel to the light incident surface 110a of the light guide plate 110, it may also be understood that an angle range of the included angle between the extending direction of the optical microstructures 132 and the first extending direction may be 85 degrees to 95 degrees. Moreover, the prism structures 152 of the second prism sheet 150 may have a second extending direction, and the second extending direction may be substantially perpendicular to the light incident surface 110a of the light guide plate 110. More specifically, the extending direction of ridge lines 152R of the plurality of prism structures 152 is, for example, substantially parallel to the direction X in FIG. 2B. In other words, an angle range of the included angle between the extending direction of the optical microstructures 132 and the second extending direction may be 85 degrees to 95 degrees. In some embodiments, the first extending direction and the second extending direction may be substantially the same, and the vertical projections of the ridge lines 142R and the ridge lines 152R on the light exit surface 110b of the light guide plate 110 may both be perpendicular to the vertical projection of the ridge lines 132R on the light exit surface 110b of the light guide plate 110. In some embodiments, the first extending direction and the second extending direction may be different, but the invention is not limited thereto.

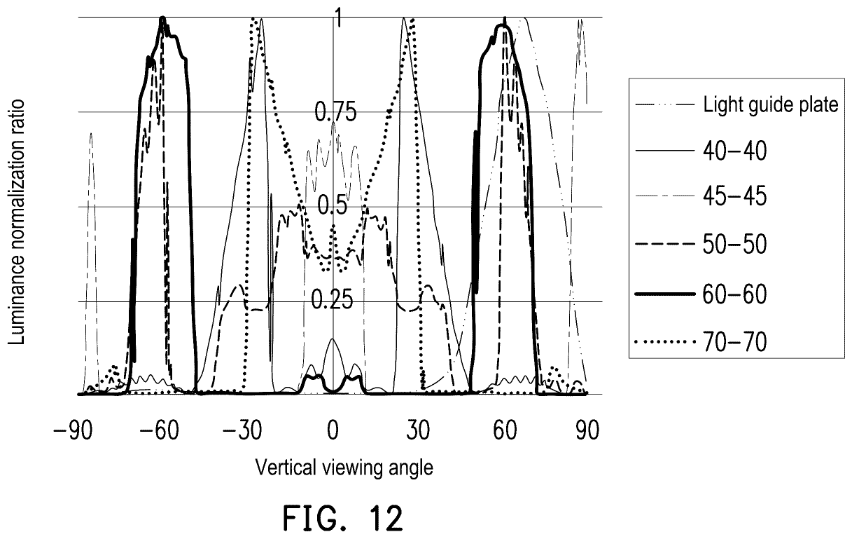

FIG. 12 is a schematic diagram of optical backtracking simulating a light guide plate and optical microstructures with different base angles of the invention. In particular, the curve “40-40” represents the relationship between each viewing angle and luminance gain when the first base angle 132c and the second base angle 132d of the optical microstructures 132 are both 40 degrees. Similarly, the curve “45-45” represents the relationship between each viewing angle and luminance gain when the first base angle 132c and the second base angle 132d of the optical microstructures 132 are both 45 degrees. For other graphs, reference may be made to the above, and details will not be described below. It may be seen from FIG. 12 that when the first base angle 132c and the second base angle 132d of the optical microstructures 132 of the present embodiment are both 60 degrees, the light emitted from a single light guide plate 110 may be more significantly overlapped with the backtracking of the optical microstructures 132 of the optical film 130, thereby producing optimal light guide effect and making the backlight module 100 have a better luminance gain value. According to the actual measurement results, via the above configuration of the first prism sheet 140, the optical film 130, and the second prism sheet 150, the luminance gain of the backlight module 100 may reach 182%, thus significantly improving the luminance and the efficiency of the backlight module 100, so that the brightness of the display device 10 may be significantly improved under the same power. Or, on the basis of power reduction, the display device 10 may still maintain the same brightness, thus effectively reducing the energy consumption of the energy storage device (such as a battery), and prolonging the use time of the display device 10.

In other embodiments, the backlight module 100 may further include a reflective sheet (not shown) disposed at a side of the light guide plate 110 away from the light exit surface 110b. Specifically, the reflective sheet and the optical film 130 may be respectively disposed at two opposite sides of the light guide plate 110. The reflective sheet may be a white reflective sheet or a silver reflective sheet, since a portion of the light emitted by the light source 120 exits from the bottom surface of the light guide plate 110, resulting in loss of light energy. Therefore, the light may be reflected back to the light guide plate 110 again via the setting of the reflective sheet, so as to improve the utilization rate of light energy.

It is worth mentioning that in other embodiments, the backlight module 100 may further include a haze layer (described later). The haze layer may have a suitable haze value that may diffusely reflect the light from the light guide plate 110 via the haze layer to further make the light output of the backlight module uniform. However, the invention is not limited thereto, and the backlight module 100 of the invention may not include the haze layer.

Moreover, the optical microstructures 132 also include a vertex angle 132e away from the substrate 131. Since the optical microstructures 132 may be made by curing a UV adhesive, the vertex angle 132e formed by the optical microstructures 132 is actually in the shape of an arc. In other words, the vertex angle 132e is substantially rounded corner having a radius of curvature. In some embodiments, the radius of curvature of the vertex angle 132e may be less than or equal to 5 micrometers. By controlling the radius of curvature of the vertex angle 132e, the optical film 130 may have a better luminance gain.

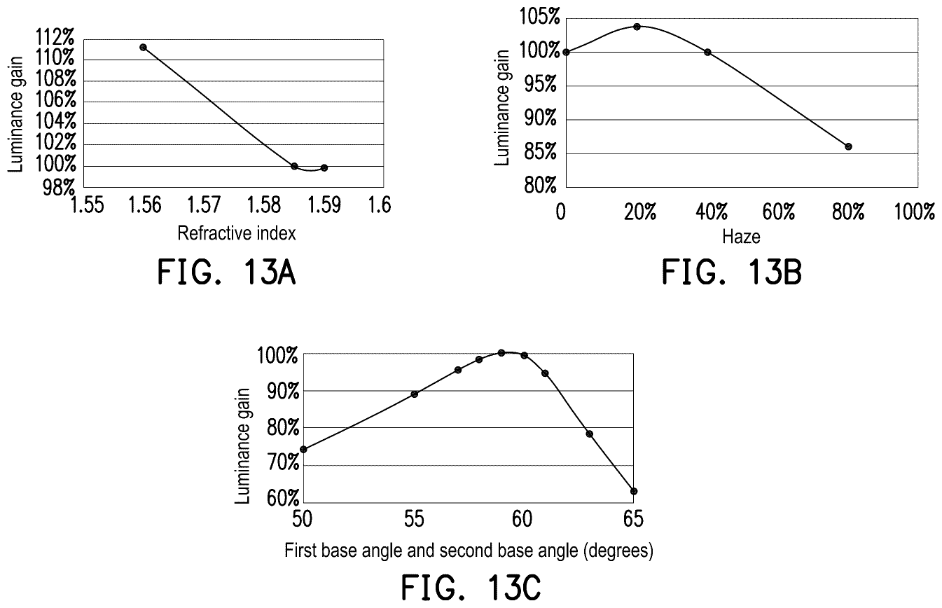

FIG. 13A to FIG. 13C are graphs of the relationship between parameters and luminance gain of simulating optical microstructures of the invention. For example, FIG. 13A is a graph of the relationship between the optical microstructures 132 with different refractive index and luminance gain under the conditions that the first base angle 132c and the second base angle 132d are both 59 degrees, there is no haze layer, and the radius of curvature of the vertex angle 132e is less than or equal to 5 micrometers. It may be seen from FIG. 13A that when the refractive index of the optical microstructures 132 is 1.56, the luminance gain may be greater, and the luminance is decreased correspondingly with the increase of the refractive index.

Similarly, FIG. 13B is a graph of the relationship between haze value and luminance gain if the backlight module 100 has a haze layer when other parameters are the same. It may be seen from FIG. 13B that when the haze value of the haze layer is 50% or less, the luminance gain may be greater, and then the luminance is decreased correspondingly with the increase of the haze value.

Moreover, FIG. 13C is a graph of the relationship between the angle values of the first base angle 132c and the second base angle 132d and luminance gain when the other parameters are the same. It may be known from FIG. 13C that, when the first base angle 132c and the second base angle 132d are equal and both 59 degrees, there may be a larger luminance gain, and when the angle value is greater than 60 degrees, the luminance is decreased correspondingly with the increase in the angle value.

Based on the above, by performing optical simulation on various parameters of the backlight module 100 or the optical microstructures 132, it is possible to know the collocation of various parameters to obtain optimal luminance gain, and via the actual measurement results, the light extraction efficiency of the backlight module 100 may be further optimized, and the luminance gain of the backlight module 100 may be increased.

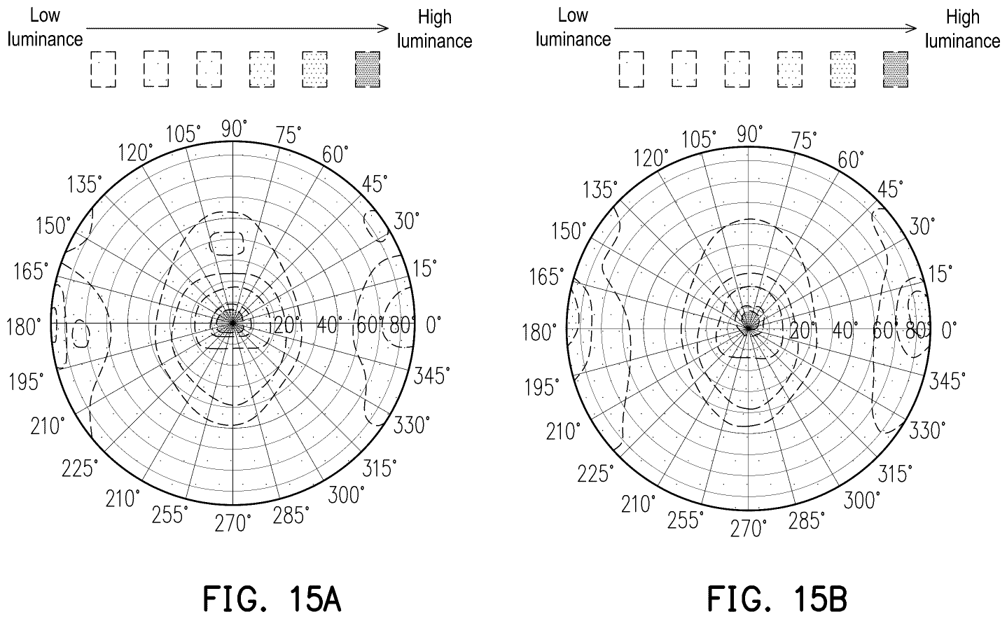

FIG. 15A and FIG. 15B are brightness distribution diagrams obtained by actually measuring an example of the backlight module of the invention. In particular, the difference between FIG. 15A and FIG. 15B is that the prism structures 142 and the prism structures 152 of FIG. 15A and the prism structures 142 and the prism structures 152 of FIG. 15B are made of UV curable adhesives with different refractive index. It may be known from FIG. 15A and FIG. 15B that, in the present embodiment, the concentration of light in the vertical direction (or the direction Z of FIG. 2A) of the backlight module 100 adopting UV curable adhesives with different refractive index is always greater than the concentration of light in the horizontal direction (or the direction X and the direction Y of FIG. 1), wherein the UV curable adhesives with different refractive index used in the present embodiment respectively have refractive index of 1.65 and 1.67 after curing, but it is not limited thereto, as long as the refractive index of the UV curable adhesive after curing is greater than 1.6. In other words, the backlight module 100 of the present embodiment may increase the ratio of light beams of the light guide plate 110 to be concentrated in the vertical viewing angle range, thereby providing high luminance gain in the vertical viewing angle range.

Some other embodiments will be enumerated below to describe the invention in detail, wherein the same components are marked with the same reference numerals, and descriptions of the same technical content is omitted. For the omitted parts, please refer to the above embodiments, which are not be repeated hereafter.

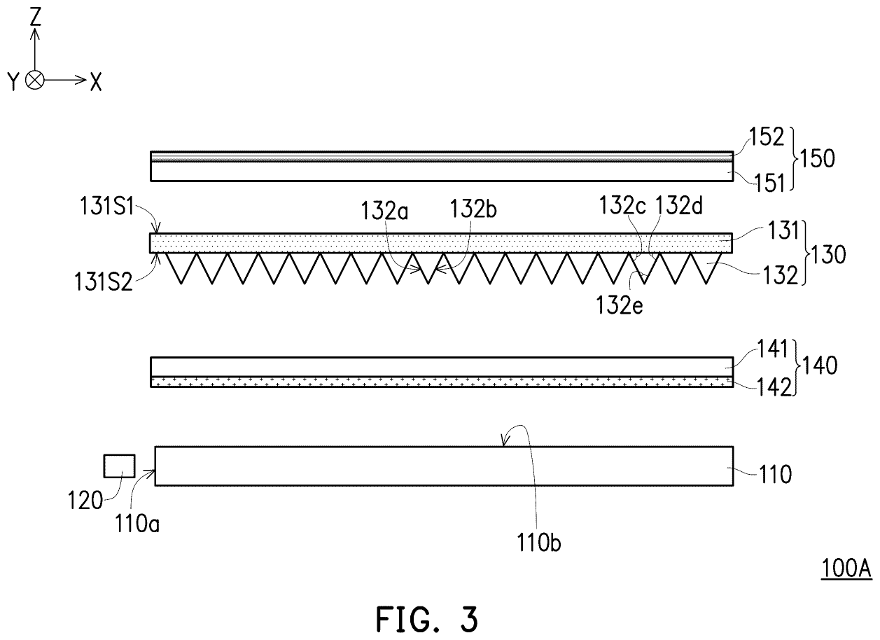

FIG. 3 is a side view of a backlight module of the second embodiment of the invention. Please refer to FIG. 3, a backlight module 100A of the present embodiment is similar to the backlight module 100 of FIG. 2A, the difference is that the positions of the plurality of optical microstructures 132 on the optical film 130 are different. Specifically, the substrate 131 of the optical film 130 of the present embodiment has a surface 131S2 opposite to the surface 131S1, and the surface 131S2 is facing the light exit surface 110b of the light guide plate 110, and the optical microstructures 132 are located at the surface 131S2 and disposed facing the light exit surface 110b of the light guide plate 110. Furthermore, the protruding direction of the optical microstructures 132 may be the same as the protruding direction of the prism structures 142 of the first prism sheet 140 (for example, they both face the direction opposite to the direction Z in FIG. 3). It may also be understood that the vertex angle 132e of the optical microstructures 132 is protruded toward the light guide plate 110. According to the actual measurement results, the backlight module 100A may also have a luminance gain similar to that of the backlight module 100, and may exhibit better optical effects.

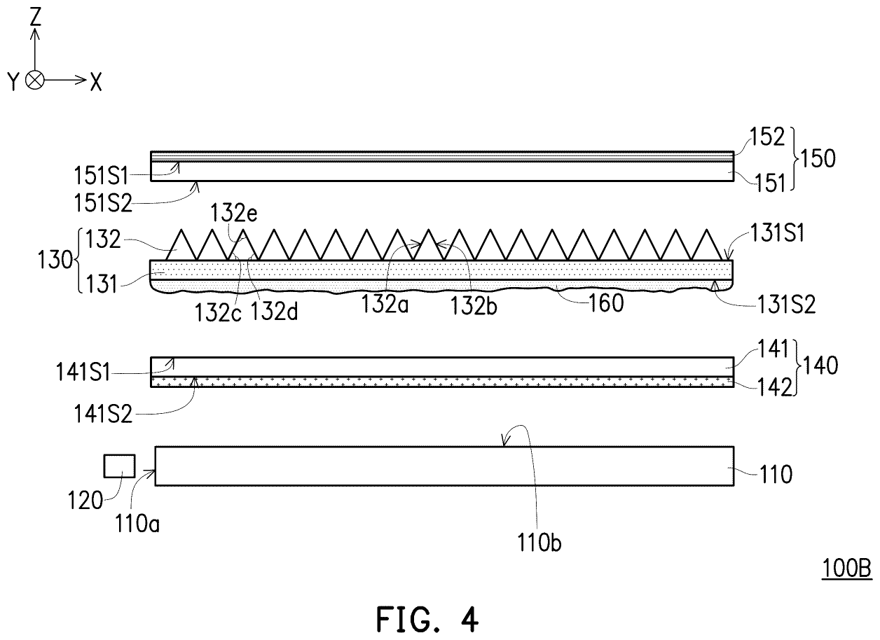

FIG. 4 is a side view of a backlight module of the third embodiment of the invention. Please refer to FIG. 4, a backlight module 100B of the present embodiment is similar to the backlight module 100 of FIG. 2A, the difference is that the backlight module 100B further includes a diffusion structure layer 160 disposed at the substrate 131 of the optical film 130. Specifically, the diffusion structure layer 160 is disposed on the surface 131S2 of the substrate 131 facing the light guide plate 110. It may also be understood that the diffusion structure layer 160 is disposed at a side of the substrate 131 away from the plurality of optical microstructures 132.

Please refer to FIG. 4 and FIG. 13B at the same time, the diffusion structure layer 160 may be the above haze layer, and the haze value of the diffusion structure layer 160 may be less than or equal to 50%. It may be seen from FIG. 13B that an excessively high haze value reduces the luminance gain of the backlight module 100B, and the emitted light of the backlight module 100B is also diverged more. However, a haze value that is too low reduces the concealment of the backlight module 100B. Due to the inevitable occurrence of detailed defects or foreign matter (such as dirt, dust particles, or lint, etc.) between the various layers of the backlight module during the assembly process, they are readily detected during the back-end quality control optical inspection process, resulting in a decrease in the assembly yield. In other words, having a suitable haze value of the diffusion structure layer 160 may improve the concealment of the backlight module 100B, thereby improving the assembly yield of the backlight module 100B, which may also be understood as, the process latitude between the elements of the backlight module 100B is improved.

The diffusion structure layer 160 may optionally include photosensitive adhesive and diffusion particles. The photosensitive adhesive is, for example, UV glue, and the material of the diffusion particles may be polymethyl methacrylate (PMMA) or polystyrene (PS). The diffusion particles may be spherical particles or irregular particles with different particle sizes, and the invention is not limited thereto. In other embodiments, the diffusion structure layer 160 may be formed by machining, sandblasting, silver particle coating, etc. at the surface 131S2 of the substrate 131. Alternatively, surface roughening may be performed via lithographic etching process, UV light, or plasma to form uneven microstructures distributed in random numbers at the surface 131S2 of the substrate 131. That is, the material of the diffusion structure layer 160 may be the same as the substrate 131, but the invention is not limited thereto. Since the diffusion structure layer 160 may have a specific haze value, the backlight module may omit an additional diffusion plate, and compared with conventional backlight modules, the thickness of the device may be further reduced, which is also beneficial to the reduction of the weight of the backlight module and the display device, and less assembly elements are also beneficial to improve the assembly yield of the backlight module 100B and reduce production costs.

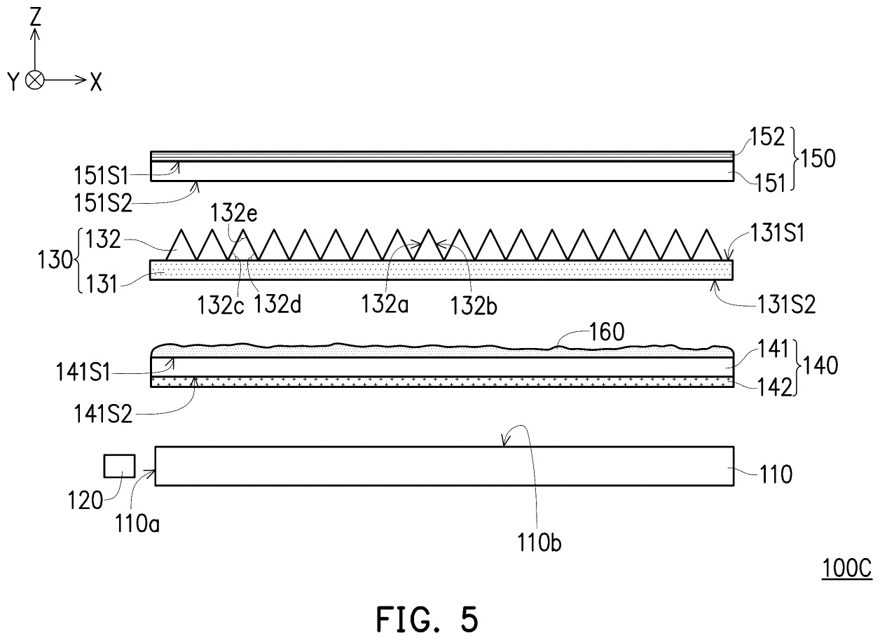

FIG. 5 is a side view of a backlight module of the fourth embodiment of the invention. Referring to FIG. 5, a backlight module 100C of the present embodiment is similar to the backlight module 100B of FIG. 4, and the difference is that the diffusion structure layer 160 of the backlight module 100C is disposed at the first prism sheet 140. More specifically, the diffusion structure layer 160 is disposed on the surface 141S1 of the first carrier plate 141 of the first prism sheet 140 and disposed opposite to the prism structure 142 on the surface 141S2 of the first carrier plate 141. It may also be understood that the diffusion structure layer 160 is disposed at a side of the first prism sheet 140 away from the plurality of prism structures 142.

The diffusion structure layer 160 of the backlight module 100C may also be provided by the above method. For example, uneven microstructures distributed in random numbers may be formed at the surface 141S1 of the carrier plate 141 to form the diffusion structure layer 160, and related descriptions are as provided above, and are not be repeated herein. Based on the above, the backlight module 100C may also achieve similar technical effects to the backlight module 100B.

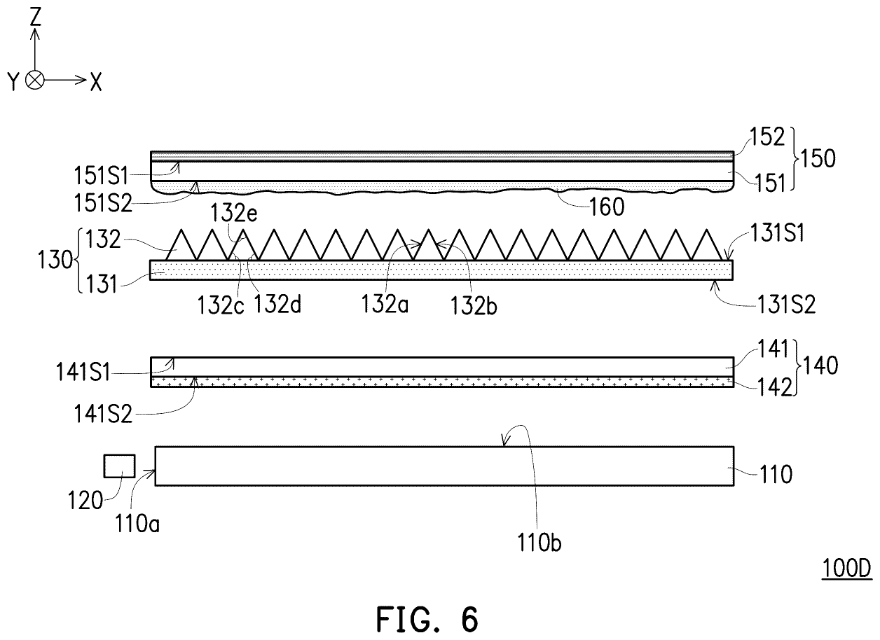

FIG. 6 is a side view of a backlight module of the fifth embodiment of the invention. Referring to FIG. 6, a backlight module 100D of the present embodiment is similar to the backlight module 100C of FIG. 5, and the difference is that the diffusion structure layer 160 of the backlight module 100D is disposed at the second prism sheet 150. More specifically, the diffusion structure layer 160 is disposed on the surface 151S2 of the second carrier plate 151 of the second prism sheet 150 and disposed opposite to the prism structure 152 on the surface 151S1 of the second carrier plate 151. It may also be understood that the diffusion structure layer 160 is disposed at a side of the second prism sheet 150 away from the plurality of prism structures 152.

Similarly, the diffusion structure layer 160 of the backlight module 100D may also adopt the above method to form the diffusion structure layer 160 on the surface 151S2 of the carrier plate 151. For relevant descriptions, reference may be made to the above, and details are not repeated herein. The backlight module 100D may also achieve high luminance gain, and has similar technical effects to the backlight module 100B.

In other embodiments, the number of the diffusion structure layer 160 may be more than one. In other words, the diffusion structure layers 160 may be respectively disposed at at least one of a side of the substrate 131 away from the plurality of optical microstructures 132 (for example, disposed at the surface 131S2 of the substrate 131 in FIG. 4 to FIG. 6), at a side of the first prism sheet 140 away from the plurality of prism structures 142 (for example, disposed at the surface 141S1 of the carrier plate 141 in FIG. 4 to FIG. 6), and at a side of the second prism sheet 150 away from the plurality of prism structures 152 (for example, disposed at the surface 151S2 of the carrier plate 151 in FIG. 4 to FIG. 6). By disposing the plurality of diffusion structure layers 160 on the optical film 130, the first prism sheet 140, and the second prism sheet 150 respectively, it is also possible to conveniently adjust the suitable haze value and improve the luminance gain of the backlight module.

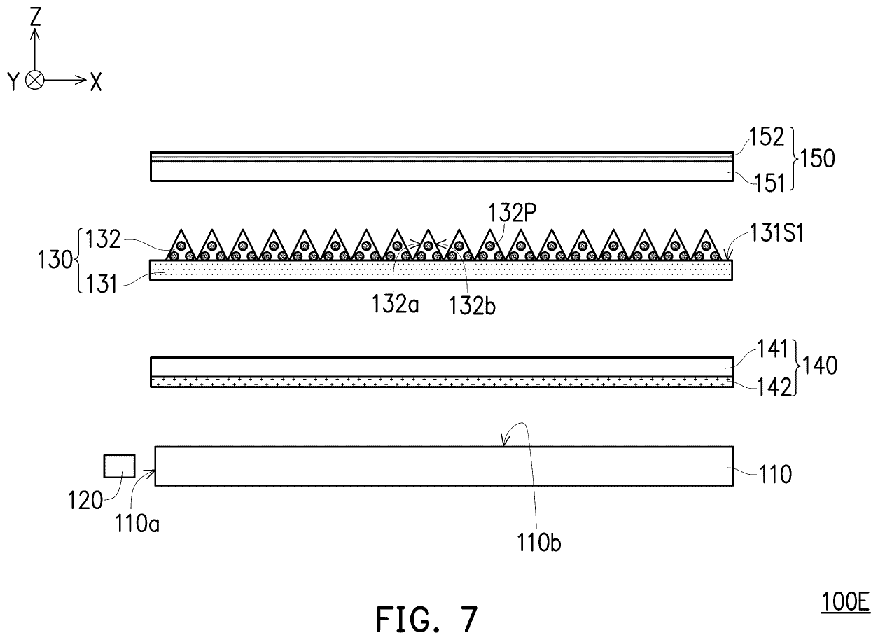

FIG. 7 is a side view of a backlight module of the sixth embodiment of the invention. Please refer to FIG. 7, a backlight module 100E of the present embodiment is similar to the backlight module 100 of FIG. 2A, the difference is that: the optical microstructures 132 of the backlight module 100E further include diffusion particles 132P dispersed in the optical microstructures 132. More specifically, the optical microstructures 132 of the backlight module 100E may have a haze value.

Via the diffusion particles 132P in the optical microstructures 132, the haze value of the optical film 130 of the backlight module 100E may be less than or equal to 50%. In this way, the backlight module 100E does not need to be provided with the diffusion structure layer 160 like the backlight module 100B, the backlight module 100C, and the backlight module 100D, that is, the haze needed by the backlight module 100E may be provided by the diffusing particles 132P in the optical microstructures 132. The backlight module 100E may also achieve similar technical effects to the backlight module 100B, which is not repeated herein.

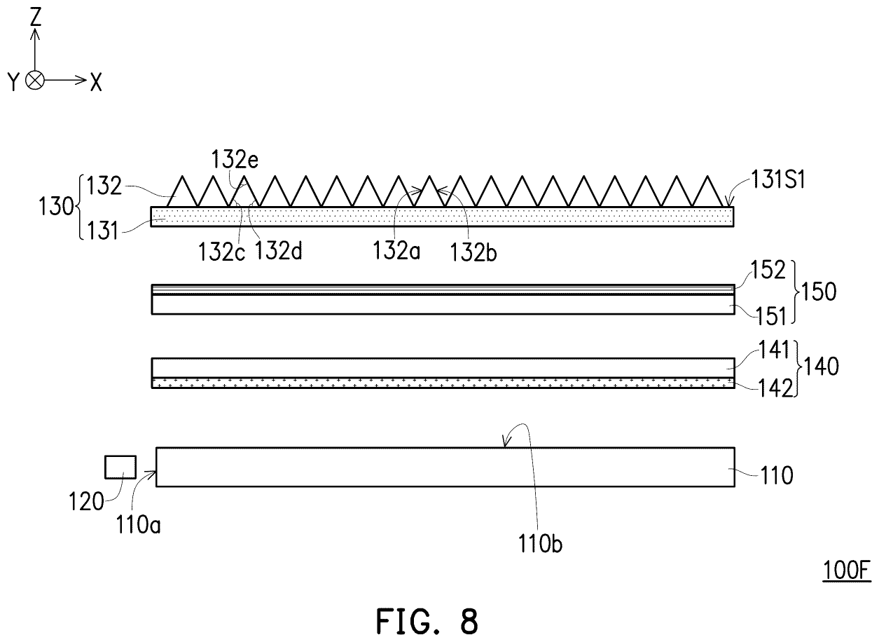

FIG. 8 is a side view of a backlight module of the seventh embodiment of the invention. Please refer to FIG. 8, a backlight module 100F of the present embodiment is similar to the backlight module 100 of FIG. 2A, the difference is that the positions of the optical film 130, the first prism sheet 140, and the second prism sheet 150 are different. In detail, the first prism sheet 140 and the second prism sheet 150 of the backlight module 100F are disposed between the optical film 130 and the light guide plate 110, and the second prism sheet 150 is disposed between the optical film 130 and the first prism sheet 140. In other embodiments, the first prism sheet 140 may also be disposed between the optical film 130 and the second prism sheet 150, and the invention is not limited thereto. The backlight module 100F configured above may also achieve the technical effect of luminance gain similar to that of the backlight module 100 and focus on vertical viewing angle.

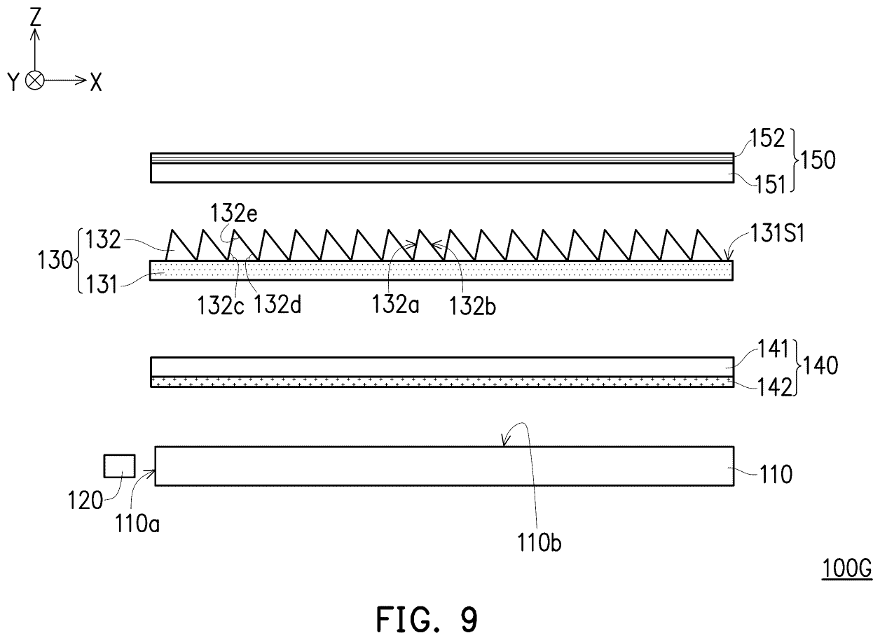

FIG. 9 is a side view of a backlight module of the eighth embodiment of the invention. Please refer to FIG. 9, a backlight module 100G of the present embodiment is similar to the backlight module 100 of FIG. 2A, the difference is that: the first base angle 132c of the optical microstructures 132 of the backlight module 100G is greater than the second base angle 132d. Specifically, the first base angle 132c is the base angle in any one of the optical microstructures 132 closer to the light source 120, and may also be called a backlight angle; the second base angle 132d is the base angle in any one of the optical microstructures 132 farther away from the light source 120, and may also be referred to as an incoming light angle. In other words, the first base angle 132c is located between the light source 120 and the second base angle 132d. In some embodiments, the first base angle 132c may be, for example, 70 degrees, and the second base angle 132d may be, for example, 59 degrees. That is to say, the first base angle 132c of the present embodiment is disposed at a side in any one of the optical microstructures 132 close to the light source 120, and the first base angle 132c is greater than the second base angle 132d. The backlight module 100G may also have high luminance gain (described below).

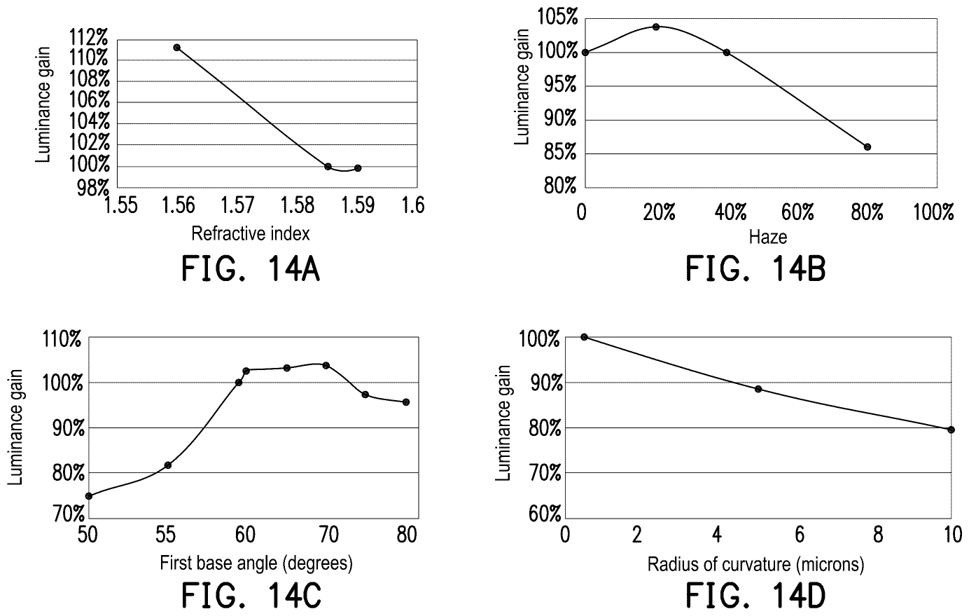

FIG. 14A to FIG. 14D are diagrams of the relationship between various parameters and luminance gain of simulating the optical microstructures of the invention on the basis of fixed second base angle. FIG. 14C is the graph of the relationship between the first base angle 132c of the backlight module 100G and luminance gain under conditions such as the second base angle 132d is fixed at 59 degrees, the refractive index of the optical microstructures 132 is 1.585, and the radius of curvature of the vertex angle 132e is less than or equal to 0.5 microns. Please refer to FIG. 9 and FIG. 14C at the same time. It may be seen from FIG. 14C that when the second base angle 132d is fixed at 59 degrees and the first base angle 132c is less than 59 degrees, the backlight module 100G has a lower luminance gain, thus increasing the proportion of stray light at an angle (e.g., the direction Z in FIG. 9) perpendicular to the forward direction. However, when the first base angle 132c is greater than 59 degrees (that is, the incoming light angle is greater than the backlight angle), the backlight module 100G may have better luminance gain. By setting an angle range of the first base angle 132c of 59 degrees to 70 degrees and greater than the second base angle 132d, the luminance gain and the optical effect of the backlight module 100G may be further optimized, and the light extraction efficiency of the backlight module 100G may be effectively improved.

Moreover, the light extraction efficiency of the backlight module 100G may also be further optimized continuously. FIG. 14A is a graph of the relationship between the refractive index of the optical microstructures 132 of the backlight module 100G and luminance gain when other parameters are the same. It may be seen from FIG. 14A that when the refractive index of the optical microstructures 132 is 1.56, the luminance gain may be better, and then the is luminance decreased correspondingly with the increase of the refractive index. Similarly, FIG. 14B is a graph of the relationship between haze value and luminance gain if the backlight module 100G has a haze layer (such as the diffusion structure layer 160) under the condition that other parameters are the same. It may be seen from FIG. 14B that the greater the haze, the lower the luminance and the more divergent the viewing angle. Similarly, FIG. 14D is a graph of the relationship between the radius of curvature of the vertex angle 132e of the optical microstructures 132 of the backlight module 100G and luminance gain when other parameters are the same. It may be seen from FIG. 14D that the larger the radius of curvature of the vertex angle 132e is, the lower the luminance gain of the backlight module 100G. Therefore, the radius of curvature of the vertex angle 132e may be less than or equal to 5 microns.

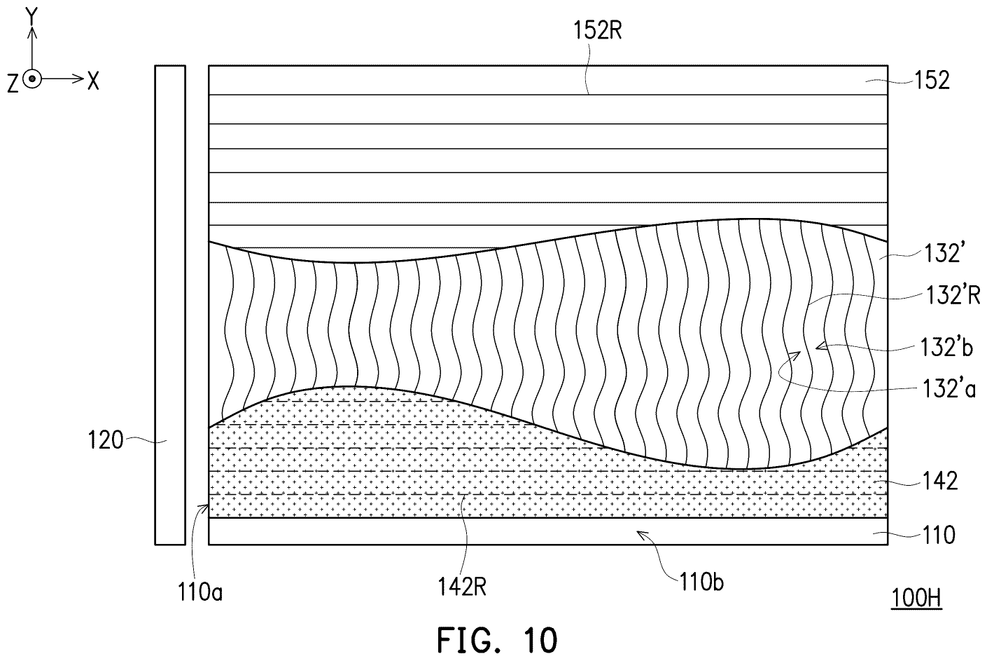

FIG. 10 is a top view of a backlight module of the ninth embodiment of the invention. In order to facilitate the presentation of the extended relationship of optical microstructures 132′, the prism structure 142, and the prism structure 152, FIG. 10 omits the illustration of the substrate 131, the carrier plate 141, and the carrier plate 151 in FIG. 2A. The positions and descriptions of related elements are as provided above, and are not repeated herein. Please refer to FIG. 10, a backlight module 100H of the present embodiment is similar to the backlight module 100 of FIG. 2B, the difference is that the optical microstructure configuration of the backlight module 100H is different.

Specifically, the vertical projection of the extending path of the optical microstructures 132′ of the backlight module 100H at the substrate 131 is wavy shape. It may also be understood that the optical microstructures 132′ are still extended in a direction (that is, extended toward the direction Y in FIG. 10) approximately parallel to the light incident surface 110a of the light guide plate 110, and ridge lines 132′R formed by the vertex angle 132′ between a first inclined surface 132′a and a second inclined surface 132′b is a curved curve in the top view of the backlight module 100H.

It is worth mentioning that since the vertical projection of the optical microstructures 132′ at the light exit surface 110b of the light guide plate 110 is a curve, bright and dark fringes (moiré) generated by optical interference between the optical film 130, the first prism sheet 140, and the second prism sheet 150 may be effectively suppressed, and the light output uniformity of the backlight module 100H may be effectively improved.

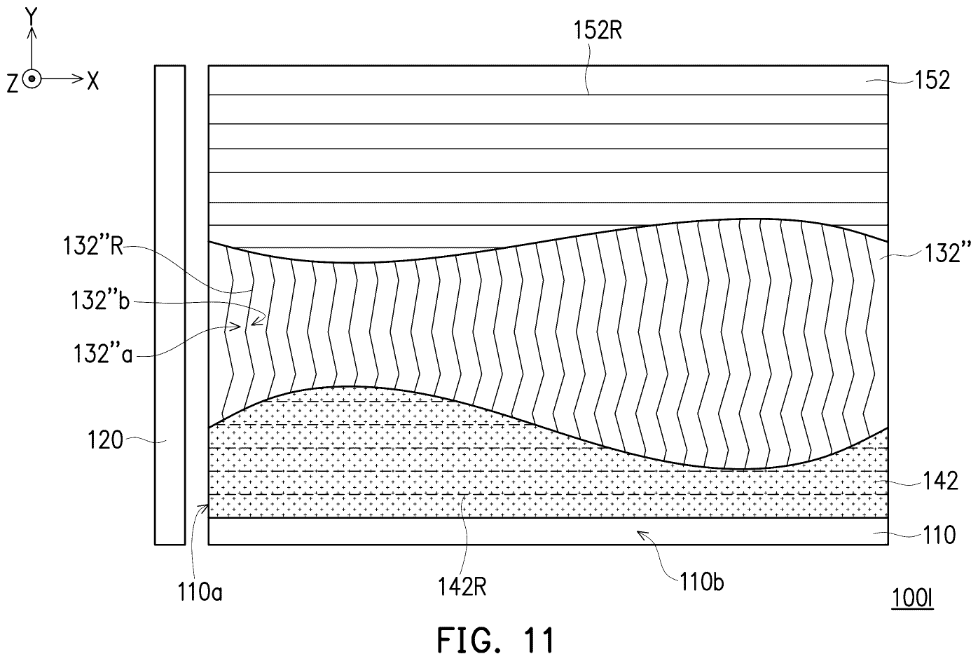

FIG. 11 is a top view of a backlight module of the tenth embodiment of the invention. In order to facilitate the presentation of the extended relationship of optical microstructures 132″, the prism structure 142, and the prism structure 152, FIG. 11 omits the illustration of the substrate 131, the carrier plate 141, and the carrier plate 151 in FIG. 2A. The positions and descriptions of related elements are as provided above, and are not repeated herein. Please refer to FIG. 11, a backlight module 100I of the present embodiment is similar to the backlight module 100H of FIG. 10, the difference is that the optical microstructure configuration of the backlight module 100I is different. Specifically, the vertical projection of the extending path of the optical microstructures 132″ of the backlight module 100I on the substrate 131 is jagged shape. It may also be understood that the optical microstructures 132″ are still extended in a direction (that is, extended toward the direction Y in FIG. 11) approximately parallel to light incident surface 110a of the light guide plate 110, and ridge lines 132″R formed between a first inclined surface 132″a and a second inclined surface 132″b is jagged shape with an angular in the top view of the backlight module 100I.

Since the vertical projection of the optical microstructures 132″ at the light exit surface 110b of the light guide plate 110 is a jagged shape, bright and dark fringes (moiré) generated by the optical interference between the optical film 130, the first prism sheet 140, and the second prism sheet 150 may be effectively suppressed, and the light output uniformity of the backlight module 100I is effectively improved.

It is worth mentioning that, in other embodiments, the optical microstructures 132′ or the optical microstructures 132″ may also be disposed up and down along the thickness direction (that is, the direction Z of FIG. 10 or FIG. 11) of the backlight module 100H or the backlight module 100I. It may also be understood that the optical microstructures 132′ or the optical microstructures 132″ not only may present a wavy or jagged shape on the surface formed by the direction X and the direction Y in FIG. 10 and FIG. 11, but may also present a wavy or jagged shape on the surface formed by the direction X and the direction Z. In other words, the optical microstructures 132′ or the optical microstructures 132″ may be floatingly disposed at the top, bottom, left, and right directions of the optical film 130, which may also effectively suppress bright and dark fringes (moiré) produced by optical interference to improve the light output uniformity of the backlight module 100H or the backlight module 100I, but the invention is not limited thereto.

Based on the above, the backlight module of the invention may only include one optical film and two prism sheets in an exit light direction of the light exit surface of the light guide plate to further reduce the overall thickness of the backlight module. The manufacturing difficulty and the cost of the backlight module are reduced, and the product yield rate is further increased. Moreover, since an angle range of the base angle of the optical microstructures on the optical film is 50 degrees to 70 degrees, the actually measured luminance gain of the backlight module of the invention may reach 182%, thus significantly improving the luminance of the backlight module and improving the brightness and the light extraction efficiency of the display device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a light guide plate having a light incident surface and a light exit surface connected to each other;
a light source disposed at a side of the light incident surface of the light guide plate;
an optical film overlapped with the light exit surface of the light guide plate, and the optical film comprises:
a substrate having a surface; and
a plurality of optical microstructures disposed on the surface of the substrate, and an extending direction of the plurality of optical microstructures is substantially parallel to the light incident surface, wherein any one of the plurality of optical microstructures comprises a first inclined surface and a second inclined surface, there is a first base angle between the first inclined surface and the surface, and there is a second base angle between the second inclined surface and the surface, wherein an angle range of each of the first base angle and the second base angle is 50 degrees to 70 degrees; and
a first prism sheet and a second prism sheet overlapped with the optical film and each of the first prism sheet and the second prism sheet having a plurality of prism structures, the plurality of prism structures of the first prism sheet have a first extending direction, the plurality of prism structures of the second prism sheet have a second extending direction, an angle range of an included angle between an extending direction of the plurality of optical microstructures and the first extending direction is 85 degrees to 95 degrees, and an angle range of an included angle between the extending direction of the plurality of optical microstructures and the second extending direction is 85 degrees to 95 degrees.

2. The backlight module of claim 1, wherein the plurality of optical microstructures further comprise a vertex angle away from the substrate, and a radius of curvature of the vertex angle is less than or equal to 5 microns.

3. The backlight module of claim 2, wherein the vertex angle is protruded toward the light guide plate.

4. The backlight module of claim 1, wherein the first base angle and the second base angle are substantially equal.

5. The backlight module of claim 1, further comprising:
a diffusion structure layer disposed at at least one of the substrate, the first prism sheet, and the second prism sheet, wherein a haze of the diffusion structure layer is less than or equal to 50%.

6. The backlight module of claim 5, wherein the diffusion structure layer is disposed at at least one of a side of the substrate facing away from the plurality of optical microstructures, a side of the first prism sheet facing away from the plurality of prism structures, and a side of the second prism sheet facing away from the plurality of prism structures.

7. The backlight module of claim 1, wherein a material of the plurality of optical microstructures comprises a plurality of diffusion particles.

8. The backlight module of claim 1, wherein the first prism sheet and the second prism sheet are disposed between the optical film and the light guide plate.

9. The backlight module of claim 1, wherein the optical film is disposed between the first prism sheet and the second prism sheet, and the first prism sheet is located between the optical film and the light guide plate.

10. The backlight module of claim 1, wherein the plurality of prism structures of the first prism sheet face the light exit surface of the light guide plate.

11. The backlight module of claim 1, wherein the first base angle is disposed at a side in the any one of the plurality of optical microstructures close to the light source, and the first base angle is greater than the second base angle.

12. The backlight module of claim 1, wherein a vertical projection of an extending path of the plurality of optical microstructures at the substrate has a wavy shape or a jagged shape.

13. A display device, comprising:
a display panel; and
a backlight module, wherein the display panel is disposed on the backlight module, and the backlight module comprises:
a light guide plate having a light incident surface and a light exit surface connected to each other;
a light source disposed at a side of the light incident surface of the light guide plate;
an optical film overlapped with the light exit surface of the light guide plate, and the optical film comprises:
a substrate having a surface; and
a plurality of optical microstructures disposed on the surface of the substrate, and an extending direction of the plurality of optical microstructures is substantially parallel to the light incident surface, wherein any one of the plurality of optical microstructures comprises a first inclined surface and a second inclined surface, there is a first base angle between the first inclined surface and the surface, and there is a second base angle between the second inclined surface and the surface, wherein an angle range of each of the first base angle and the second base angle is 50 degrees to 70 degrees; and
a first prism sheet and a second prism sheet overlapped with the optical film and each of the first prism sheet and the second prism sheet having a plurality of prism structures, the plurality of prism structures of the first prism sheet have a first extending direction, the plurality of prism structures of the second prism sheet have a second extending direction, an angle range of an included angle between the extending direction of the plurality of optical microstructures and the first extending direction is 85 degrees to 95 degrees, and an included angle between the extending direction of the plurality of optical microstructures and the second extending direction is 85 degrees to 95 degrees.
